(19) United States
(12) Patent Application Publication
(10) Pub. No.: US 2010/0173110 A1
(43) Pub. Date: Jul. 8, 2010

(54) Skid Resistant Membrane

(76) Inventors: Robert A. Wiercinski, Lincoln, MA (US); Jyoti Seth, Andover, MA (US)

Correspondence Address: W. R. GRACE & CO.-CONN;ATTENTION: PATENT DEPARTMENT, 62 WHITTMORE AVENUE, CAMBRIDGE, MA, 02140, US

(21) Appl. No.: 12/663,081

(22) PCT Filed: Jul. 10, 2008
(86) PCT No.: PCT/US08/69645

§ 371 Date: Dec. 4, 2009

Related U.S. Application Data
(60) Provisional application No. 60/949,061, filed on Jul. 11, 2007.

(51) Int. Cl. E04D 5/10; B32B 37/00; B32B 7/12; B32B 5/12; C09J 7/02; C09J 7/04; B32B 11/10; B32B 27/12; D06N 5/00

(52) U.S. Cl. 428/40.3; 156/249

(57) ABSTRACT

Described is a skid-resistant roofing underlayment that, in its most basic form, includes three layers—a flexible substrate layer, an adhesive layer and a release liner layer. The flexible substrate comprises a woven polyolefin mesh that includes a first plurality of polyolefin tapes extending in a major direction interwoven with a second plurality of polyolefin tapes extending in a cross direction. The adhesive layer includes a modified bitumen pressure sensitive adhesive with a sufficient cohesive strength to prevent exudation of the adhesive through the flexible substrate at elevated temperatures.

### FIELD OF THE INVENTION

The present invention relates to a skid-resistant, self-adhering membrane that is useful as a roofing underlayment.

### BACKGROUND OF THE INVENTION

Roofing underlayments are typically installed over the roof deck and under the primary roof covering or overlayment, which can be asphalt shingles, metal shingles, or metal roofing, tiles such as Spanish or slate tile, wood shakes, concrete, slate, etc. The underlayment provides a secondary moisture barrier to protect the roof deck and building interior from moisture that may penetrate through the primary roof covering. Commercially effective underlayments must maintain their strength and integrity even after exposure to the elements. Underlayments are used both in new construction and in re-roofing projects.

It is known in the waterproofing art to combine a pre-formed waterproofing membrane, such as a rubberized bitumen/oil layer, with a carrier support sheet or film, and to utilize this as an underlayment. The carrier support film may comprise a variety of materials, such as rubber, plastic, and/or metal, or combinations of the same. The use of metals is desirable, for example, to improve dimensional stability of the support film, which is subjected to oil migration from the oil-plasticized bitumen layer. It has also been desirable to employ cross-laminated plastic films, such as high density polyethylene, for improved stability of the carrier support sheet.

Such pre-formed waterproofing membrane laminates are considered “sheet-like” because they are sufficiently flexible that they can be rolled up and transported after manufacture to the job site where they are unrolled and installed on the building surface. This kind of membrane laminate, useful as an underlayment on sloped roofs, is commercially available from Grace Construction Products (W.R. Grace & Co.-Conn.) under the name “ICE & WATER SHIELD” (a registered trademark of W.R.Grace & Co.-Conn.) The underlayment is applied to the roof deck before installation of the overlayment. The function of the membrane underlayment is to seal around roofing fasteners, seal to the deck, seal to itself at overlaps, and to protect against damage from ice dams and wind-driven rain. Another commercially available example of an underlayment is “TRI-FLEX 30”, (a product also available from Grace Construction Products) which is spun-bonded polypropylene coated with a thin layer comprising U.V. stabilized polypropylene on both of its surfaces.

In addition to its water shedding capabilities, an important characteristic of a roofing underlayment is its skid or slip resistance. Since roofing applicators must walk on the underlayment during roofing installation, the exposed surface should have a sufficiently high coefficient of friction, even when wet, so as to minimize or prevent an applicator from slipping when walking or standing on the surface. Skid resistant underlayments are disclosed, for example, in U.S. Pat. No. 5,687,517, U.S. Pat. No. 6,308,482, US 2003/0215594, US 2004/0127120 and WO2007/021653.

Non-adhering (mechanically fastened) membranes comprising a woven polyolefin mesh are known. Such products include Titanium™ UDL (InterWrap Inc.), Sharkskin™ Comp (Kirsch Building Products, LLC), Sharkskin™ Ultra (Kirsch Building Products, LLC), Polyprotector® UDL (Polyglass USA, Inc.), ROOFTOPGUARD (Nemco Industries Inc.), and Palisade™ Synthetic Underlayment (SDP Advanced Polymer Products Inc.). None of these products include a bare, woven mesh as the top layer. Generally, these products have poor dimensional stability and are particularly subject to excessive shrinkage. FelTex™ underlayment (System Components Corporation) is a non-adhering underlayment that has an uncoated, woven mesh as the top layer.

Self-adhering membranes comprising woven fabrics are known. But these are extrusion coated on the top side. This detracts from the benefit of skid resistance provided by the woven fabric. These membranes also exhibit inadequate dimensional stability. Commercially available products are made by Interwrap and sold under the trade name Titanium™ PSU. A roofing underlayment with an openwork mesh as the bottom surface is disclosed in WO99/40271. Other membranes that include a woven polyolefin mesh as an internal layer are disclosed in U.S. Pat. No. 6,308,482 and U.S. Pat. No. 6,925,766. One type of membrane disclosed in the '766 patent (see FIG. 5) includes, as an external layer laminated to a rubberized bituminous layer, a mesh with interconnecting strands and nodes protruding from its upper surface, optionally coated with a tacky material.

A product sample displayed at a trade show, but not believed to be commercially available, is FelTex™ self-adhering roofing underlayment (System Components Corporation) that comprises a polypropylene mesh (24×9) with a thin (about 20 mils or about 0.5 mm), non-bituminous adhesive on the lower surface and a release liner on the adhesive. The thin layer of adhesive, which is non-bituminous, does not provide good nail sealing, deck sealing, and lap sealing. In addition, the black membrane has very low reflectivity that can allow the surface to reach extremely high temperatures in direct sunlight. This can cause degradation of the mesh and can reduce the shear strength of the adhesive, which can result in exudation of the adhesive through the mesh as well as deformation of the membrane under load.

### SUMMARY OF THE INVENTION

One embodiment of the invention is directed to a skid-resistant roofing underlayment. In its most basic form, the roofing underlayment will comprise three layers—a flexible substrate layer, an adhesive layer and a release liner layer.

One layer comprises a flexible substrate having a first major surface adapted to be exposed to foot traffic and an opposite second major surface adapted to be applied against a roof surface. The flexible substrate extends lengthwise in a major direction (MD) and widthwise in a cross direction (CD). The flexible substrate comprises a woven polyolefin mesh comprising a first plurality of polyolefin tapes extending in the MD interwoven with a second plurality of polyolefin tapes extending in the CD. The first plurality of tapes comprises about 15 to about 30 tapes per inch (about 6 to about 12 tapes per cm) and the second plurality of tapes comprises about 3 to about 9 tapes per inch (about 1.2 to about 3.5 tapes per cm). Preferably, the ratio of the first plurality to the second plurality is about 2.8 to about 6. The exposed surface of the underlayment (i.e., the first major surface of the flexible substrate) has a minimum reflectance of 20%, preferably at least 30%, as measured via ASTM C1549.

The next layer comprises an adhesive layer affixed to the second major surface of the flexible substrate. The adhesive layer comprises a modified bitumen pressure sensitive adhesive. While the adhesive layer may be any thickness suitable for the intended application, preferably it will have a thickness of about 20 to 100 mils (0.51 to 2.54 mm). The adhesive preferably has sufficient cohesive strength to prevent exudation of the adhesive through the flexible substrate onto the first major surface of the flexible substrate. It is highly undesirable if adhesive bleeds through the substrate, since it will stick to the shoes of workers walking on the underlayment.

The third layer includes a release liner removably affixed to the adhesive layer. The release liner permits the underlayment to be stored in a roll, while enabling the user to easily unroll it during application. The release liner is removed just prior to application of the underlayment to a roof surface. The roofing underlayment is adapted to be applied to a roof surface such that the MD (or length) of the flexible substrate is perpendicular to the slope of the roof after application.

In addition, the present invention includes a method of waterproofing a roof surface by unrolling the above-described skid resistant roofing underlayment, removing the release liner, and adhering the underlayment to the roof surface.

### BRIEF DESCRIPTION OF THE DRAWINGS

FIG. 1 is a schematic diagram of a roofing underlayment in accordance with one embodiment of the present invention.

FIG. 2 is a schematic diagram of a roofing underlayment in accordance with another embodiment of the present invention.

FIG. 3 is a schematic diagram of a roofing underlayment in accordance with yet another embodiment of the present invention.

FIG. 4 is a schematic diagram of a roofing underlayment in accordance with still another embodiment of the present invention.

FIG. 5 is a magnified top view of a roofing underlayment in accordance with one embodiment of the present invention.

### DETAILED DESCRIPTION OF THE PREFERRED EMBODIMENTS

As depicted in FIG. 1, in its most basic form, the roofing underlayment 1 of the present invention will comprise three layers—a flexible substrate layer 2, an adhesive layer 3 and a release liner layer 4.

One layer comprises a flexible substrate 2 having a first major surface 12 (the upper surface as shown in FIG. 1) adapted to be exposed to foot traffic and an opposite second major surface (the lower surface as shown in FIG. 1) adapted to be applied against (or facing) a roof surface. The flexible substrate extends lengthwise in a major direction (MD) and widthwise in a cross direction (CD). The flexible substrate comprises a woven polyolefin mesh comprising a first plurality of polyolefin tapes extending in the MD interwoven with a second plurality of polyolefin tapes extending in the CD. The first plurality of tapes comprises about 15 to about 30 tapes per inch (about 6 to about 12 tapes per cm) and the second plurality of tapes comprises about 3 to about 9 tapes per inch (about 1.2 to about 3.5 tapes per cm). Preferably, the ratio of the first plurality to the second plurality is about 2.8 to about 6, more preferably about 3 to about 5.

In a more preferred embodiment, the first plurality of tapes comprises about 21 to about 27 tapes per inch (about 8.2 to about 10.6 tapes per cm) and the second plurality of tapes comprises about 4 to about 8 tapes per inch (about 1.6 to about 3.2 tapes per cm). In a most preferred embodiment, the first plurality of tapes comprises about 24 tapes per inch (about 9.4 tapes per cm) and the second plurality of tapes comprises about 5 to about 7 tapes per inch (about 1.9 to about 2.8 tapes per cm). It is also highly preferred that the ratio of the first plurality to the second plurality is about 4.

The polyolefin may comprise polypropylene or polyethylene. Preferably, the polyolefin comprises polypropylene and the flexible substrate will be a woven polypropylene mesh. The polyolefin mesh layer will typically have a thickness in the range of about 2 mils to about 10 mils (about 0.05 mm to about 0.25 mm), preferably about 4 mils to about 8 mils (0.10 mm to 0.20 mm). The weight of the woven polyolefin mesh will typically be in the range of about 40 to 120 g/m², preferably about 60 to 100 g/m².

The woven polyolefin mesh should preferably comprise less than about 20% open space, particularly for those embodiments where the mesh is in direct contact with the modified bitumen pressure sensitive adhesive. This will minimize the level of adhesive exudation through pores in the mesh. More preferably, the woven fabric should comprise less than about 10% open space, most preferably less than about 5% open space.

The tapes used to produce the mesh are generally produced by first extruding a polyolefin film, orienting the polyolefin film in the machine direction, slitting the film into narrow widths (or tapes), and annealing the tapes. The tapes are then woven into a mesh. If desired, annealing may be done after weaving.

The next layer comprises an adhesive layer 3 affixed to the second major surface of the flexible substrate 2. The adhesive layer comprises a modified bitumen pressure sensitive adhesive. While the adhesive layer may be any thickness suitable for the intended application (for example, 20 to 100 mils (0.51 to 2.54 mm)), preferably it will have a thickness of at least 35 mils (0.88 mm).

The adhesive layer may comprise any rubber modified bitumen pressure sensitive adhesive that is known in the art. The rubber modified bitumen comprises bitumen and one or more rubbers selected from the group consisting of SIS (styrene-isoprene-styrene block copolymers), SBS (styrene-butadiene-styrene block copolymers), SEBS (styrene-ethylene-butylene-styrene block copolymers), SBR (styrene-butadiene rubber), natural rubber, butyl rubber, polyisoprene, polyisobutylene, chloroprene, ethylene-propylene rubber, ethylene alpha olefin, polybutadiene, nitrile rubbers, and acrylic rubber. The rubber modified bitumen also typically includes a processing oil such as an aromatic or naphthenic oil. The wt. % rubber is about 10% to 22%; the wt % bitumen is about 43% to 90%; and the wt. % processing oil is about 0% to 35%. The rubber modified bitumen may also comprise an inorganic filler such as silica, calcium carbonate, talc, or clay. If present, the wt. % filler may be about 0% to 30% of the total.

The adhesive preferably has sufficient cohesive strength to prevent exudation of the adhesive through the flexible substrate onto the first major surface of the flexible substrate, particularly at elevated temperatures. It is highly undesirable if adhesive bleeds through the substrate, since it will stick to the shoes of workers walking on the underlayment.

One suitable method to gauge cohesive strength is via measurement of % strain as a function of time utilizing a standard creep test. The creep test is conducted with a circular, parallel plate rheometer, such as an AR 1000 rheometer (TA Instruments, Inc.), using a sample thickness of approximately 40 mils (1.0 mm) and a plate diameter of 1.5 in. (3.8 cm). The sample is heated to 180° F. and a constant torque of 10,000 micro Newton meters (μN-m) is applied. Percent strain vs. time is measured over a 900 sec time period. Preferably, the adhesive will have a cohesive strength, measured as % strain at 900 sec, of about 10,000% to about 100,000%.

An alternative method to gauge cohesive strength is to plot shear rate vs. time using data taken from the above-described creep test. Using this method, a suitable high cohesive strength adhesive will have a shear rate of about 0.2 sec⁻¹ to about 1.5 sec⁻¹ at 600 to 900 sec.

The adhesive layer may comprise one or more layers. For example, the adhesive layer may comprise a first adhesive layer affixed to the polyolefin mesh and a second adhesive layer affixed to the first adhesive layer. The first and second adhesive layers may comprise different rubber modified bitumen pressure sensitive adhesives with different properties—e.g., the first adhesive layer may have greater cohesive strength or greater stiffness than the second adhesive layer. In addition, for embodiments that include at least two adhesive layers, a polymeric film support layer may be interposed between the two adhesive layers (which can be the same or different) to add stiffness. For such an embodiment, the separation between the flexible substrate or mesh layer and the polymer film may be 25% to 75% of the total thickness of the adhesive layer.

A further embodiment includes a plasticizer on the adhesive layer to improve adhesion of the membrane to a roof surface without significantly compromising the cohesive strength of the adhesive layer. The thickness of the plasticizer layer may be about 0.1 mil to 5 mils (0.0025 mm to 0.13 mm). The plasticizer may include, but is not limited to, aromatic oils, naphthenic oil, liquid polybutadiene, liquid polybutene, and vegetable oils.

The third layer includes a release liner 4 removably affixed to the adhesive layer 3. The release liner permits the underlayment to be stored in a roll, while enabling the user to easily unroll it during application. The release liner may be any material suitable for such use and typically comprises a wax-coated or siliconized paper or plastic film. The release liner is removed just prior to application of the underlayment to a roof surface.

The roofing underlayment is adapted to be applied to a roof surface such that the MD (or length) of the flexible substrate is perpendicular to the slope of the roof after application. This is shown, for example, in FIG. 5, which depicts a magnified view of the upper surface of the flexible substrate of the roofing underlayment of the present invention, revealing the exposed polyolefin tape edges of the woven polyolefin mesh. In this depiction, the direction of roof slope is the vertical axis, which would be the expected direction of skidding (as indicated by the arrow). The major direction (MD), or length, of the flexible substrate (and therefore the MD of the underlayment) extends along the horizontal axis (perpendicular to the roof slope). The cross direction (CD), or width, of the flexible substrate (and therefore the CD of the underlayment) extends along the vertical axis (parallel to the roof slope).

During use, a shoe sole placed on top of the mesh will contact the elevated areas of the mesh, that is, where the tapes overlap. Skidding is retarded by temporary mechanical interlock between the shoe sole and the edges of the tapes in the elevated areas. The retardation of skidding is enhanced by deformation of the tapes while interlocked with the shoe sole. Skid resistance should be proportional to the number of interlocks with the shoe sole. The number of interlocks will be enhanced by increasing the number of tapes per unit length perpendicular to the direction of skidding (i.e., in the MD). Increasing the length of these tapes between overlaps equates to minimizing the number of tapes per unit length parallel to the direction of skidding (i.e., in the CD). Thus, a preferred woven polyolefin mesh will have a higher ratio of tapes per unit length in the MD to tapes per unit length in the CD, typically a ratio of about 2.8 to about 6.

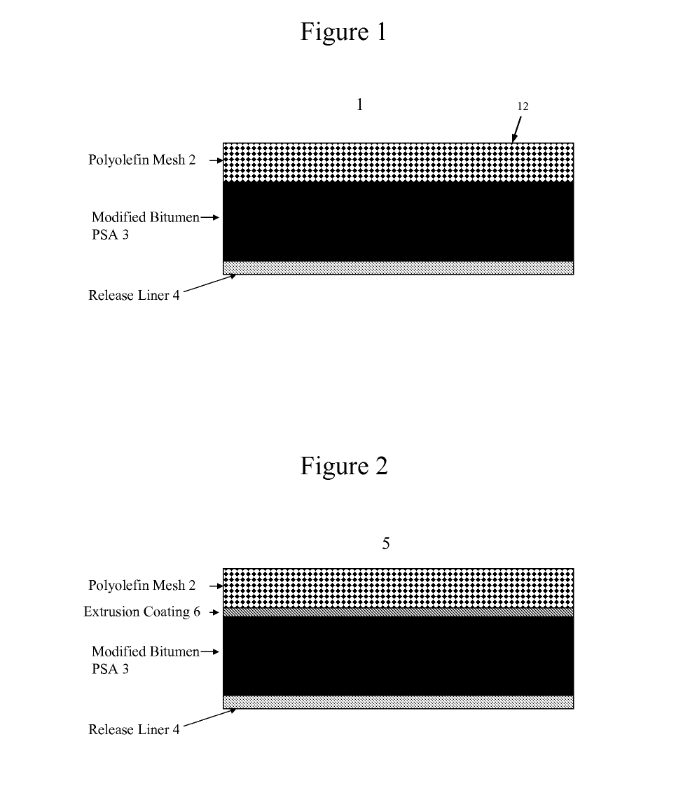

An additional embodiment of the invention is depicted in FIG. 2. In this embodiment, a polymer film 6 is interposed between the polyolefin mesh 2 and the adhesive layer 3. That is, the polymer film 6 is applied directly onto the second major surface of the polyolefin mesh (e.g., by extrusion coating with die, direct roll coater, reverse roll coater, gravure coater, knife over roll coater, etc., followed by cooling, curing or drying), then the adhesive layer is applied to the polymer film (or coating). The polymer film extrusion coating may comprise one or more polymers including a polyolefin, such as polyethylene or polypropylene, ethylene-propylene copolymer, ethylene-methylacrylate copolymer, ethylene-butylacrylate copolymer, ethylene vinyl acetate, polvinylidene chloride, copolymers of vinylidene chloride, nylon, and other g/m² to 100 g/m².

The polymer film 6 (or extrusion coating) may be applied to the entire surface of the side of the woven polyolefin mesh in contact with the adhesive layer, or it may be applied over only part of the surface. The edges of the woven polyolefin mesh extending in the MD optimally may be left uncoated from 0.1 in. to 1 in (0.25 to 2.54 cm) from the edge on both sides of the mesh to prevent or minimize upward edge curl that can often occur when the membrane reaches elevated rooftop temperatures. Another option for minimizing upward edge curl is to use a polymer for the extrusion coating that has low oil absorption.

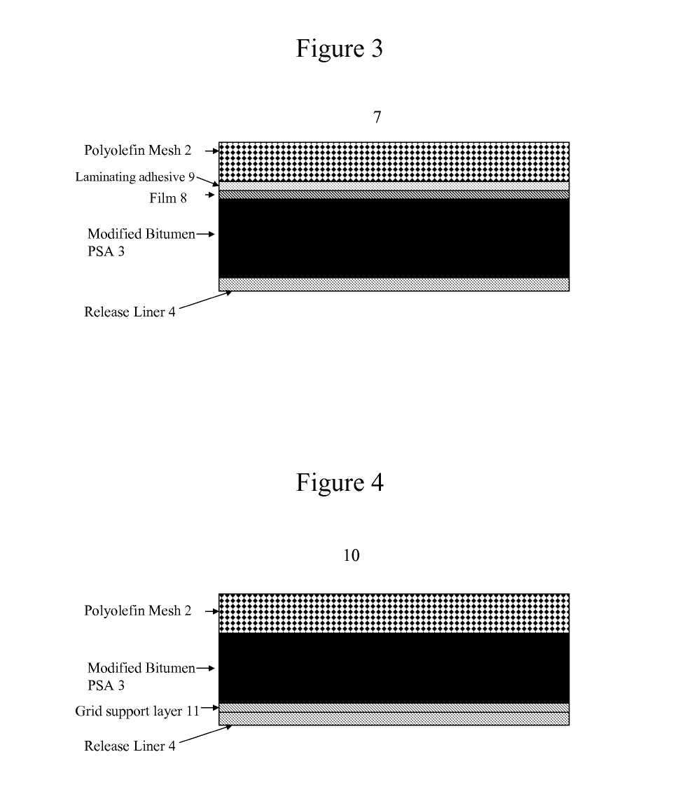

A further embodiment of the invention is depicted in FIG. 3. In this embodiment, a polymer film 8 is interposed between the polyolefin mesh 2 and the adhesive layer 3. The pre-manufactured polymer film 8 may be adhered to the second major surface of the polyolefin mesh with a laminating adhesive 9. The polymer film 8 may comprise a polyolefin, such as polyethylene or polypropylene or a mixture thereof, a polyester, such as polyethylene terephthalate, a polyamide, or a polyvinylchloride. Preferred films include biaxially oriented polyethylene terephthalate, biaxially oriented polypropylene, polyvinylidene chloride and copolymers, and polyamides. The polymer film thickness may be about 0.1 mils to 2 mils (0.0025 to 0.050 mm), preferably about 0.2 to 1.0 mils (0.005 to 0.025 mm). The laminating adhesive 9 may be a pressure sensitive adhesive or may comprise a hot melt adhesive, or a reactive adhesive such as an epoxy or an isocyanate. The laminating adhesive thickness may be about 0.2 mils to 2 mils (0.005 to 0.050 mm). The polymer film 8 may be applied to the entire surface of the side of the woven polyolefin mesh in contact with the adhesive layer, or it may be applied over only part of the surface.

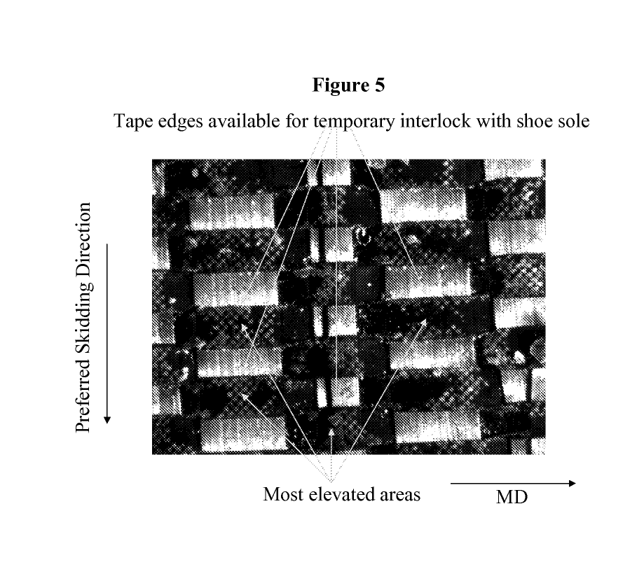

Any of the above-described embodiments may include a grid support layer interposed between the flexible substrate and the release liner to add stiffness to the underlayment to improve ease of application. Preferably, the separation between the flexible substrate and the grid support layer 11 is about 50% to 100% of the thickness of the adhesive layer, more preferably about 75% to 100% of the thickness of the adhesive layer. For example, one such embodiment is depicted in FIG. 4. In this embodiment, a grid support layer 11 is interposed between the adhesive layer 3 and the release liner 4.

The grid support layer may comprise a polyolefin, such as polypropylene or polyethylene, a polyester, glass or a combination of these. Polyester and glass are preferred. The weight of the grid may be about 0.1 oz/yd to 3 oz/yd. (3.3 g/m² to 100.4 g/m²), preferably 0.2 oz/yd to 1 oz/yd (6.6 g/m² to 67 g/m²). Numerous grid geometries are possible, including alignment of fibers parallel, perpendicular, or at other angles to the MD in the same grid. The spacing between fibers in the MD and CD may range from 0.1 in. to 2 in. (0.25 cm to 5.08 cm), preferably 0.25 in. to 1 in. (0.63 cm to 2.54 cm). The grid support layer may be completely coated or partially coated on the backside with the adhesive. Partial coating of the grid support layer further enhances ease of application by making the membrane repositionable.

### Example 1

A membrane with the construction depicted in FIG. 2 was fabricated. Mesh 2 is an 80 g/m² woven polypropylene mesh (Propex) having 24 tapes/in. in the MD and 6 tapes/in. in the CD. The mesh has an extrusion coating 6 comprised of a 30 g/m² layer comprising a 4:1 mixture of polypropylene and low density polyethylene. Adhesive layer 3 is 36 mils (0.91 mm) of a rubber modified bitumen pressure sensitive adhesive (12% SBS rubber and 88% bitumen) having a shear rate of 0.6 sec⁻¹ between 600 sec to 900 sec and a % strain of 50,000% at 900 sec, measured in accordance with the aforedescribed test. Release liner 4 is 6 mil silicone coated paper. The membrane is made by coating a hot melt of the modified bitumen adhesive onto the release liner, cooling the adhesive, then laminating the extrusion coated side of the polypropylene mesh to the adhesive. This membrane provides excellent skid resistance compared to other membranes, particularly under wet, dry dirty or wet dirty conditions.

Skid resistance is measured by adhering a 3 ft.×3 ft. (91 cm×92 cm) sample of the test membrane to a plywood surface positioned at a test angle of 40°. Then a test walker walks over the test sample and judges the skid resistance to be significantly better (+2), moderately better (+1), the same (0), moderately worse (−1), or significantly worse (−2) than a control sample. The samples are tested dry, wet, dry-dirty and wet-dirty. “Dirty” means that one tablespoon of 325 mesh ground calcium carbonate is brushed onto half the sample.

Membranes of the invention are preferably dimensionally stable. This means that the membrane wrinkles little or not at all after outdoor exposure in a hot climate. Also the membrane does not grow or shrink significantly in either the MD or the CD.

High shrinkage on a roof deck may result in unsealing of end and side overlaps, tenting in inside corners and valleys, and debonding from the roof surface, particularly in vertical areas. High shrinkage (or growth) in the MD is most undesirable because the membrane may be applied in lengths as long as 100 ft. (30 m), which exacerbates the problem. This is less important in the CD, where typical underlayments are generally less than or equal to 4 ft. (1.2 m) in width.

Variables that affect dimensional stability of membranes of the present invention include:

the level of annealing imparted to tapes used to produce the mesh; process induced orientation stresses imparted to the mesh and the extrusion coated layer (if present) during various manufacturing steps;
the coefficient of thermal expansion (CTE) of the mesh and the extrusion coated layer (if present);
oil absorbtivity of the mesh and the extrusion coated layer (if present); the reflectivity of the mesh surface.

The shrinkage (or growth) characteristics of the mesh layer play a key role in the dimensional stability of the membrane. The dimensional stability may be evaluated for the woven fabric alone, a woven fabric extrusion coated on one side with a polymeric film, or a woven fabric extrusion laminated to a film. The following test may be used to measure dimensional stability of a sample. The sample is cut to 12 in.×12 in. (30 cm×30 cm). Precise marks are made with digital calipers on the sample surface 10 in. (25.4 cm) apart. The marks are made in both the MD and CD, about midway between the edges of the mesh. The mesh is then heated for 24 hours in a still oven at 180° F. (82° C.). After cooling the mesh to room temperature, the distance between the marks is measured and the % shrinkage (or % growth if applicable) is calculated.

Preferably, the shrinkage in the MD should be 0% to 2% to insure good dimensional stability, most preferably 0% to 1.0%. Preferably, the shrinkage in the CD should be 0% to 2%, most preferably 0% to 1.0%. Preferably, any growth in either the MD or CD should be 0% to 1%, most preferably about 0%.

It is preferred that the exposed surface of the underlayment of the present invention is reflective to highly reflective. Thus, it is preferred that the flexible substrate comprises a white or grey woven polyolefin mesh. A minimum reflectance of at least 20%, more preferably at least 30%, as measured by ASTM C 1549 is preferred. The woven polyolefin mesh with a high reflectance keeps the adhesive cooler on a roof than a woven polyolefin mesh with low reflectance. The cooler temperature combined with a high cohesive strength adhesive helps to preventing exudation of the adhesive through the mesh and also helps to prevent sliding of the mesh under load on a sloped surface, such as when an applicator is standing in place.

It is preferred that the woven polyolefin mesh comprise stabilizers to retard degradation when exposed to direct sunlight. Stabilizers include pigments like carbon black and titanium dioxide. Hindered amine light stabilizers, antioxidants and ultraviolet absorbers may also be used. Various combinations of these ingredients may be used.

What is claimed is:

1. A skid-resistant roofing underlayment comprising
a flexible substrate having a first major surface adapted to be exposed to foot traffic and an opposite second major surface adapted to be applied against a roof surface, the flexible substrate extending lengthwise in a major direction (MD) and widthwise in a cross direction (CD), wherein the flexible substrate comprises a woven polyolefin mesh comprising a first plurality of polyolefin tapes extending in the MD interwoven with a second plurality of polyolefin tapes extending in the CD, wherein the first plurality comprises about 15 to about 30 tapes per inch (about 6 to about 12 tapes per cm) and the second plurality comprises about 3 to about 9 tapes per inch (about 1.2 to about 3.5 tapes per cm), and wherein the ratio of the first plurality to the second plurality is about 2.8 to about 6;
an adhesive layer affixed to said second major surface, wherein the adhesive layer comprises a rubber modified bitumen pressure sensitive adhesive with a thickness of at least 20 mils (0.51 mm), wherein the adhesive has sufficient cohesive strength to prevent exudation of the adhesive through the flexible substrate onto the first major surface; and
a release liner removably affixed to the adhesive layer;
wherein the roofing underlayment is adapted to be applied to a roof surface such that the MD of the flexible substrate is perpendicular to the slope of the roof after application.

2. The underlayment of claim 1, wherein the first plurality comprises about 21 to about 27 tapes per inch (about 8.2 to about 10.6 tapes per cm) and the second plurality comprises about 4 to about 8 tapes per inch (about 1.6 to about 3.2 tapes per cm);

3. The underlayment of claim 1, wherein the first plurality comprises about 24 tapes per inch (about 9.4 tapes per cm) and the second plurality comprises about 5 to about 7 tapes per inch (about 1.9 to about 2.8 tapes per cm);

4. The underlayment of claim 1, wherein the ratio of the first plurality to the second plurality is about 4.

5. The underlayment of claim 1, wherein the adhesive has a cohesive strength, measured as % strain, of about 10,000% to about 100,000% at 900 sec. for a 40 mil (1 mm) sample tested at 180° F. at torque of 10,000 μN-m with a circular parallel plate viscometer with a plate diameter of 1.5 in. (3.8 cm).

6. The underlayment of claim 1, wherein the adhesive has a shear rate of about 0.2 sec⁻¹ to about 1.5 sec⁻¹ at 600 to 900 sec for a 40 mil (1 mm) sample tested at 180° F. at torque of 10,000 μN-m with a circular parallel plate viscometer with a plate diameter of 1.5 in. (3.8 cm).

7. The underlayment of claim 1, wherein the adhesive layer comprises a first adhesive layer affixed to the second major surface and a second adhesive layer affixed to the first adhesive layer.

8. The underlayment of claim 7, wherein the second adhesive layer has different properties than the first adhesive layer.

9. The underlayment of claim 8, wherein the first adhesive layer has a greater cohesive strength than the second adhesive layer.

10. The underlayment of claim 7, wherein a polymeric film support layer is interposed between the first adhesive layer and the second adhesive layer.

11. The underlayment of claim 1 further comprising a plasticizer on the adhesive layer.

12. The underlayment of claim 1, wherein the second major surface of the flexible substrate includes a polymeric film adhered to all or part of the surface, wherein the polymer film is interposed between the second major surface and the adhesive layer.

13. The underlayment of claim 12, wherein the polymer film is coated directly onto the second major surface of the flexible substrate.

14. The underlayment of claim 12, wherein the polymer film is adhered to the second major surface of the flexible substrate with a laminating adhesive.

15. The underlayment of claim 1, wherein the underlayment exhibits shrinkage in the MD of 0% to 2%, wherein shrinkage is calculated by measuring the change in distance between marks placed 10 in. (25.4 cm) apart on a 12 in.×12 in. (30 cm×30 cm) sample after heating the sample at 180° F. (82° C.) for 24 hours, then cooling it to room temperature.

16. The underlayment of claim 15, wherein the underlayment exhibits shrinkage in the CD of 0% to 2%.

17. The underlayment of claim 15, wherein the underlayment exhibits shrinkage in the MD of 0% to 1%.

18. The underlayment of claim 17, wherein the underlayment exhibits shrinkage in the CD of 0% to 1%.

19. The underlayment of claim 1 further comprising a grid support layer interposed between the flexible substrate and the release liner.

20. The underlayment of claim 1, wherein the exposed surface of the underlayment exhibits a minimum reflectance of at least 20% as measured by ASTM C 1549.

21. The underlayment of claim 1, wherein the woven polyolefin mesh comprises woven polypropylene.

22. The underlayment of claim 1, wherein the woven polyolefin mesh comprises a stabilizer to prevent degradation of the mesh by sunlight.

23. The underlayment of claim 1, wherein the adhesive layer a thickness of at least 35 mils (0.88 mm)

24. A method of waterproofing a roof surface comprising removing the release liner from the skid-resistant roofing underlayment according to claim 1 and adhering the underlayment to the roof surface.
